(19) United States
(12) Patent Application Publication
(10) Pub. No.: US 2007/0118740 A1
(43) Pub. Date: May 24, 2007

(54) Authentication method and information processor

(75) Inventor: Satoshi Deishi, Ibaraki-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/600,374

(22) Filed: Nov. 16, 2006

(30) Foreign Application Priority Data
Nov. 22, 2005 (JP) JP2005-337375

(51) Int. Cl. H04L 9/00

(52) U.S. Cl. 713/158

(57) ABSTRACT

In a network made up of a plurality of terminals, each of the terminals in the network includes a digital certificate revocation list. When the digital certificate revocation list of its own is updated, the terminal sends information including the updated details to other terminal so that a digital certificate revocation list included in the other terminal in the network is updated based on the updated contents.

This application is based on Japanese patent application No. 2005-337375 filed on Nov. 22, 2005, the contents of which are hereby incorporated by reference.

### BACKGROUND OF THE INVENTION

1. Field of the Invention

The present invention relates to an authentication method based on a digital certificate and an information processor using the authentication method.

2. Description of the Related Art

Digital certificate technology has recently been widespread for the purpose of ensuring the security of communication between terminals. Since this technology enables verification of the identity of the other end of the communication, it can prevent fraudulent data from being exchanged with a so-called “identity thief”.

Digital certificates are issued by a Certificate Authority (CA) that is a third party other than parties to communication and a reliable organization. Specifications defined by ITU-TX.509 are generally known as ones of the digital certificates. A validity period is set for a digital certificate. A digital certificate that has expired cannot be used.

Even if, however, a digital certificate does not expire, in the case where the owner of the digital certificate loses a private key relating to the digital certificate or the private key is stolen by other person, the credibility of the digital certificate is damaged. In such a case, the certificate authority revokes such a digital certificate whose credibility has been damaged by listing and publishing information on a serial number or others of the digital certificate in a Certificate Revocation List (CRL). In addition, also in the case where attributes, e.g., a name, a company name or others of the owner of a digital certificate are changed, or in the case where the owner of a digital certificate has passed away, the certificate authority revokes such a digital certificate.

Accordingly, in order to improve the reliability of confirmation (authentication) of the other end of the communication, it is necessary to confirm a certificate revocation list in addition to the details of a digital certificate. As technology relating to digital certificates, there are proposed methods described in Japanese unexamined patent publication Nos. 2001-36521, 2001-77809 and 2002-217899.

According to the method described in Japanese unexamined patent publication No. 2001-36521, a common RA server stores, in advance, in a common certificate revocation list database a plurality of pieces of revocation list information obtained from a certificate revocation list of each certificate authority. Then, the common RA server determines, based on data in the common certificate revocation list database, the validity of an electronic certificate sent by a client terminal.

According to the method described in Japanese unexamined patent publication No. 2001-77809, a client makes a request to a certificate management server for an issue of an electronic certificate or invalidating the electronic certificate. A certificate management server generates an electronic certificate and registers it to a repository when a request from the client is an issue request of the electronic certificate, and the certificate management server deletes the electronic certificate from the repository and informs the client about it when the request from the client is an invalidating request of the electronic certificate. The client makes a collation request to the repository to be able to investigate whether or not the electronic certificate is invalid when the client acquires the electronic certificate.

According to the method described in Japanese unexamined patent publication No. 2002-217899, when identifying that communication between portable equipment includes an electronic certificate, a radio base station makes an inquiry for confirming the validity of the electronic certificate to a certificate verifying server. The certificate verifying server that has received the inquiry determines the validity of the certificate based on a revoked certificate database included in the certificate verifying server. Then, the determination result of the validity is sent to the portable equipment via the radio base station.

However, in the methods described in the publications mentioned above, the validity of digital certificates cannot be determined based on a certificate revocation list, for example, while a server of a certificate authority or a sever maintaining the revocation list is stopped due to the occurrence of a failure. Further, in the case where a firewall or a proxy server is provided in a network to which a terminal belongs, a certificate revocation list cannot be obtained in some cases due to the operation of a filtering function of the firewall or the proxy server. The validity of digital certificates cannot be determined in that case either.

### SUMMARY OF THE INVENTION

The present invention is directed to solve the problems pointed out above, and therefore, an object of the present invention is to ensure that the validity of a digital certificate can be determined compared to conventional cases.

A method for managing communication according to one aspect of the present invention is a method for managing communication in an information processor. The method includes storing, in a memory, revoked certificate information indicating a revoked digital certificate, receiving a digital certificate of an other end of the communication therefrom, determining, based on the revoked certificate information, whether the digital certificate thus received is revoked, receiving information on a digital certificate that is newly revoked, updating the revoked certificate information stored in the memory based on the received information on the digital certificate that is newly revoked, and sending information on the digital certificate that is newly revoked to other information processor.

Preferably, when it is determined that the digital certificate of the other end of the communication is revoked, the communication with the other end of the communication may be stopped.

Further, the method may include receiving attributes data of the other end of the communication therefrom, comparing the digital certificate with the attributes data to verify authenticity of the other end of the communication, and when the authenticity of the other end of the communication cannot be verified, determining that the digital certificate of the other end of the communication is revoked, updating the revoked certificate information, and sending, to other information processor, information indicating that the digital certificate of the other end of the communication is revoked.

A method for managing communication according to another aspect of the present invention is a method for managing communication in an information processor. The method includes storing, in a memory, revoked certificate information indicating a revoked digital certificate, receiving a digital certificate and attributes data of an other end of the communication therefrom, comparing the digital certificate with the attributes date of the other end of the communication to verify authenticity of the other end of the communication, and when the authenticity of the other end of the communication cannot be verified, determining that the digital certificate of the other end of the communication is revoked, updating the revoked certificate information, and sending, to other information processor, information indicating that the digital certificate of the other end of the communication is revoked.

A method for managing a digital certificate according to one aspect of the present invention is a method for managing a digital certificate in a network made up of a plurality of nodes. The method includes in each of the nodes, storing revoked certificate information indicating a revoked digital certificate, when each of the nodes finds an other end of communication that cannot be authenticated, adding a digital certificate of the other end of the communication to the revoked certificate information of the node and notifying other node of presence of a digital certificate that is newly revoked, and in the other node that has received the notification, updating the revoked certificate information stored in the node.

Note that a “network” in the present invention is, for example, a Peer-to-Peer (P2P) network and a “node” and an “information processor” are devices such as personal computers or workstations.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of the overall configuration of a network.

FIG. 2 is a diagram showing an example of a hardware configuration of a terminal.

FIG. 3 is a diagram showing an example of a functional configuration of the terminal.

FIG. 4 is a diagram showing an example of a logical topology of the terminals.

FIG. 5 shows an example of a digital certificate.

FIGS. 6A-6F show examples of a connection table of the terminals associated with one another as shown in FIG. 4.

FIG. 7 is a diagram showing a processing flow when an SSL communication connection is established.

FIG. 8 is a flowchart showing an example of a processing flow for examining a digital certificate.

FIG. 9 is a flowchart showing an example of a processing flow when information on a revoked digital certificate or a digital certificate with no credibility is informed by other terminal.

FIG. 10 is a diagram showing an example of processing when a digital certificate of a discarded terminal is to be used by other terminal in a fraudulent manner.

FIG. 11 is a diagram showing an example of processing when information on a revoked digital certificate is obtained from an administrator or a certificate authority.

### DESCRIPTION OF THE PREFERRED EMBODIMENTS

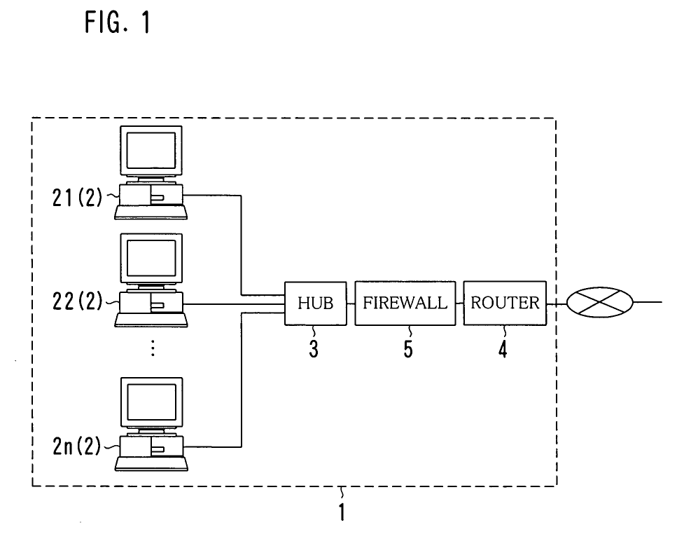

Referring to FIGS. 1-5, an example of the overall configuration of a network 1, an example of a hardware configuration of a terminal 2, an example of a functional configuration of the terminal 2, an example of a logical topology of the terminals 2 and an example of a digital certificate DC will be described.

As shown in FIG. 1, the network 1 according to the present invention is a Local Area Network (LAN) including nodes such as the plural terminals 2 (21, 22, . . . , 2n), a switching hub 3, a router 4 and a firewall 5. The terminals 2 are connected to the switching hub 3 in a star topology with twisted pair cables. The firewall 5 is provided between the switching hub 3 and the router 4. The following is a description of a case in which data communication is performed between the terminals 2 among these nodes.

The terminals 2 are devices such as personal computers, workstations or printers to perform processing of data input and output with other device. The following is a description of a case in which personal computers are used as the terminals 2.

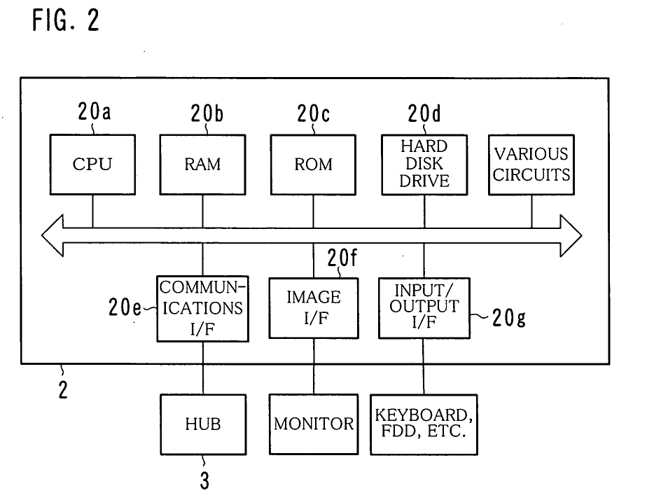

As shown in FIG. 2, the terminal 2 includes a CPU 20a, a RAM 20b, a ROM 20c, a hard disk drive 20d, a communications interface 20e, an image interface 20f, an input/output interface 20g and various other circuits or devices.

The communications interface 20e is a Network Interface Card (NIC), and is connected to any port of the switching hub 3 via the twisted pair cable. The image interface 20f is connected to a monitor, and is operable to deliver to the monitor a video signal for displaying a screen.

The input/output interface 20g is connected to an input device such as a keyboard or a mouse, or an external storage device such as a floppy disk device or a CD-ROM drive. The input/output interface 20g inputs from the input device a signal indicating the details of operation performed by a user using the input device. The input/output interface 20g makes the external storage device read data recorded on a recording medium such as a floppy disk or a CD-ROM, then to input the data. Alternatively, the input/output interface 20g outputs data for being written onto the recording medium to the external storage device.

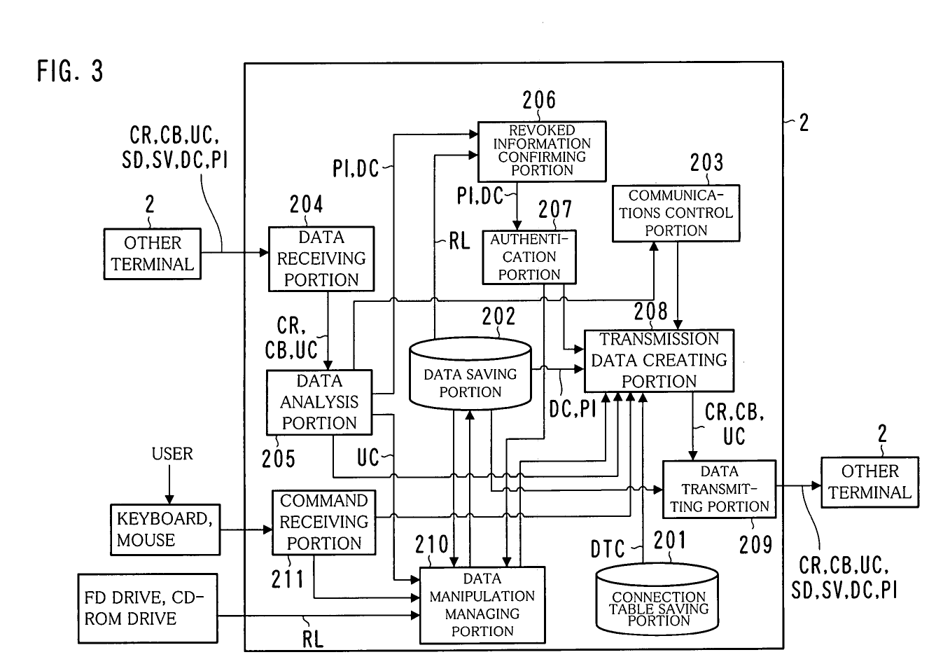

As shown in FIG. 3, on the hard disk drive 20d are stored programs and data for implementing functions of a connection table saving portion 201, a data saving portion 202, a communications control portion 203, a data receiving portion 204, a data analysis portion 205, a revoked information confirming portion 206, an authentication portion 207, a transmission data creating portion 208, a data transmitting portion 209, a data manipulation managing portion 210 and a command receiving portion 211. These programs and data are read out to the RAM 20b as necessary, and the programs are executed by the CPU 20a.

The terminals 2 are given a host name (a machine name), an IP address and a MAC address each in order to distinguish each terminal from other terminals 2. The host name can be arbitrarily named by an administrator of the network 1 or the like. The IP address is given in accordance with a rule of the network 1. The MAC address is an address that is fixedly given to the communications interface 10e of the terminal 2. In this embodiment, suppose that a host name such as “PC1”, “PC2” . . . is assigned to each of the terminals 21, 22 . . . . Hereinafter, the terminals 2 may sometimes be described by the host names.

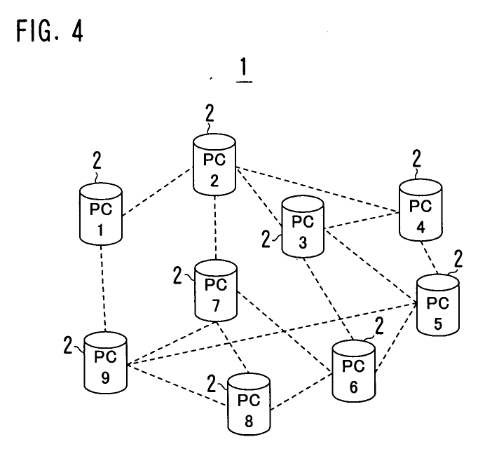

Referring to FIG. 4, the terminals 2 are assumed to be disposed in a virtual space. As shown by dotted lines, each terminal 2 is associated with at least one other terminal 2 adjacent in the virtual space. Moreover, due to these associations, all of the terminals 2 are directly or indirectly related to one another. “Directly related” means the state of being connected by one dotted line in FIG. 4 (for example, related in the manner of PC1 and PC2 or of PC1 and PC9 in FIG. 4), and “indirectly related” means the state of being connected by at least two dotted lines and a node (for example, related in the manner of PC1 and PC4 in FIG. 4). The terminal 2 sends data to other terminal 2 to which the terminal 2 itself is connected. Hereinafter, “associated” means the state of being directly associated unless otherwise noted.

Incidentally, the terminal 2 in this embodiment can perform Secure Sockets Layer (SSL) communication with other terminal 2 to which the terminal 2 itself is directly or indirectly associated. An SSL is a protocol for exchanging data safely on a network by performing encryption using a digital certificate. In this embodiment, an authentication process according to the present invention is performed, followed by the establishment of an SSL communication connection. This processing flow will be described later. As for encryption methods in the SSL communication, “RSA Key Exchange for the Secure Shell (SSH) Transport Layer Protocol”, Internet Engineering Task Force Request for Comments (IETF RFC) 4432 should be referred to.

A digital certificate is generally issued by a certificate authority in accordance with application made by a person who needs the digital certificate. The digital certificate is sent from a server of the certificate authority to a terminal of the applicant. In this embodiment, a digital certificate is issued for each terminal 2 making up the network 1. Then, each of the terminals 2 stores its own digital certificate.

In the case where the registration details of a digital certificate are changed, or a private key is stolen, lost or destroyed, the credibility of the digital certificate is damaged. Accordingly, it is necessary to revoke such a digital certificate. In general, when the need arises to revoke a digital certificate issued by a certificate authority, the certificate authority lists, in a Certificate Revocation List (CRL), information on a serial number and a revocation date of the digital certificate and publishes the same. Thereby, the digital certificate is revoked. Hereinafter, a digital certificate handled by the terminal 2 is referred to as a “digital certificate DC”. As to the digital certificate and the CRL, “Internet X.509 Public Key Infrastructure Certificate and CRL Profile”, IETF RFC 2459 describes the outline thereof.

Further, in this embodiment, the terminals 2 include a list indicating a revoked digital certificate individually, separately from a CRL of a certificate authority. Hereinafter, the list included in the terminal 2 is referred to as a “revocation list RL”. The revocation list RL is appropriately updated in line with the details of a revocation certificate list published by a certificate authority or others. Stated differently, information on revoked digital certificates DC is registered one after another. The information on the revoked digital certificates DC is registered one after another by other methods in case that a server of the certificate authority is down, that communications line failure occurs, or that the setting of preventing a connection to the server of the certificate authority is performed on the firewall 5. This will be described later.

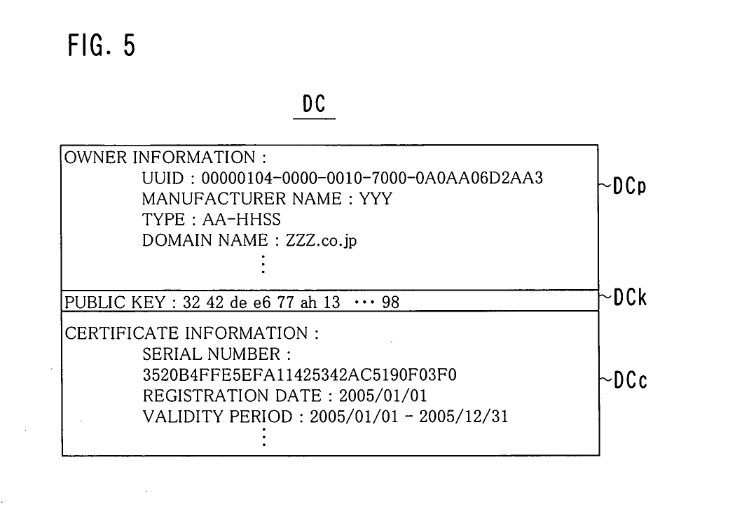

The digital certificate DC includes information on attributes of the owner of the digital certificate DC or the like, a public key, a certificate authority and attributes of the digital certificate DC. The following is a description, with reference to FIG. 5, of information that is especially important in this embodiment among these pieces of information.

As shown in FIG. 5, the digital certificate DC includes owner information DCp, a public key DCk and certificate information DCc. The owner information DCp is information regarding attributes of the terminal 2 or of the owner of the digital certificate DC. The owner information DCp includes information on, for example, a Universally Unique Identifier (UUID), a manufacturer name, a type, an IP address and a domain name. Other than these, the owner information DCp may include information such as an IP address or an e-mail address.

The “UUID” is a general-purpose identifier and is created by combining, for example, a MAC address of the terminal 2 of the owner of the digital certificate DC and a character string indicating the date and time when the UUID is issued. The “manufacturer name” shows a name of a manufacturer of the terminal 2 or the NIC provided therein. The “type” shows a type of the terminal 2 or the NIC provided therein. The “domain name” shows a name of a domain to which the terminal 2 belongs.

The public key DCk is used in order that the terminals 2 safely exchange data relating to a common key for SSL communication. Each of the terminals 2 retains a private key with which the public key DCk included in its own digital certificate DC makes a pair.

The certificate information DCc is information on attributes of the digital certificate DC itself and includes information on, for example, a serial number, a registration date or a validity period. The “serial number” is a number used for uniquely identifying the digital certificate DC. The “registration date” is a date on which the digital certificate DC is issued. The “validity period” shows the commencement and termination of the period during which the digital certificate DC is valid. The standard specifications of a general digital certificate DC and a general revocation list RL are defined as X.509 by the International Telecommunication Union (ITU).

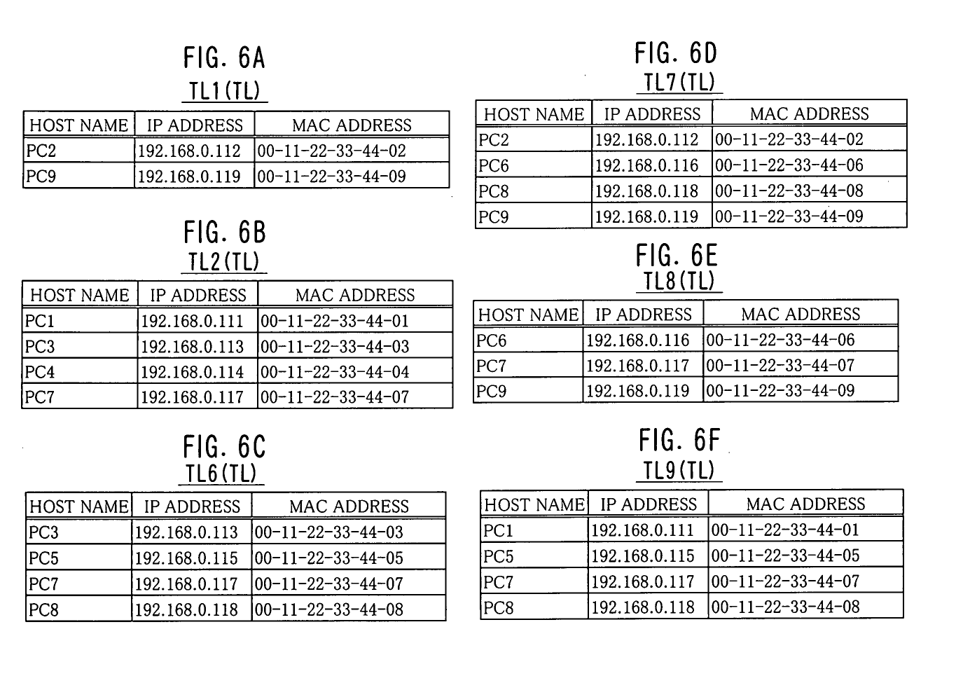

FIGS. 6A-6F show examples of a connection table TL of the terminals 2 associated with one another as shown in FIG. 4. The following is a description of processing details of each of the portions included in the terminal 2 shown in FIG. 3.

The connection table saving portion 201 saves the connection table TL indicating a list of attributes including host names, IP addresses and MAC addresses of other terminals 2 with which the terminal 2 itself is associated. For example, the connection table saving portions 201 of the PC1, PC2, PC6, PC7, PC8 and PC9 shown in FIG. 4 save the connection tables TL1, TL2, TL6, TL7, TL 8 and TL 9 respectively as shown in FIGS. 6A-6F. The details of the connection tables TL are created in advance by an administrator based on the associations of the terminals 2.

The data saving portion 202 saves, in the form of file, attributes data PI indicating attributes of the terminal 2 or a user, the digital certificate DC of the terminal 2 itself, the revocation list RL, data used by an operating system (OS) or application software, data created by the user using the application software and various other data. The attributes data PI include information on, for example, the UUID, the manufacturer name, the type or the domain name. The meaning of the information is the same as that of the owner information DCp of the digital certificate DC shown in FIG. 5. In this embodiment, upon the application of the digital certificate DC, the details described in the attributes data PI are filed with a certificate authority. Thus, the owner information DCp of the issued digital certificate DC ends up showing the same contents as those of the attributes data PI.

The communications control portion 203 performs various control processing for data communication with other terminal 2. The data receiving portion 204 receives packets necessary for the terminal 2 itself among the packets flowing through the network 1.

The data analysis portion 205 extracts necessary information from the data (hereinafter referred to as “received data”) received by the data receiving portion 204 to analyze the details thereof. Then, the data analysis portion 205 determines the type of the received data.

The revocation information confirming portion 206 confirms whether or not a digital certificate DC sent by other terminal 2 is revoked, with reference to the revocation list RL saved in the data saving portion 202.

The authentication portion 207 performs an authentication process of other terminal 2 based on a digital certificate DC, attributes data PI and others sent by the other terminal 2.

The transmission data creating portion 208 serves to generate data to be sent to other terminal 2 (hereinafter referred to as “transmission data”) based on a command issued by, for example, the communications control portion 203, the authentication portion 207 or the data manipulation managing portion 210.

The data transmitting portion 209 converts the transmission data generated by the transmission data creating portion 208 into packets and sends the same to other terminal 2.

The data manipulation managing portion 210 performs processing for saving data in the data saving portion 202, processing for updating the data saved in the data saving portion 202 or other processing. For example, every time the environment or the setting details of the terminal 2 are changed, the data manipulation managing portion 210 updates the attributes data PI. Further, the data manipulation managing portion 210 performs processing for updating the revocation list RL.

The command receiving portion 211 accepts a command that is designated by the user operating the keyboard, the mouse or others. Then, the command receiving portion 211 makes each of the portions perform processing according to the command.

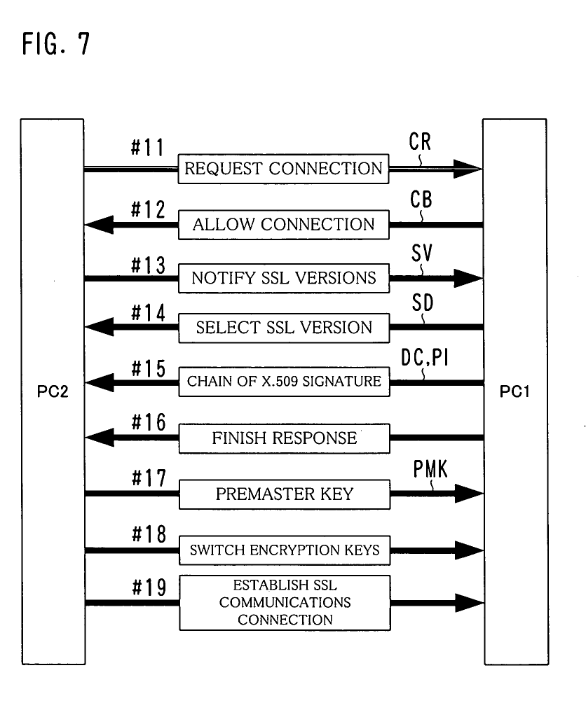

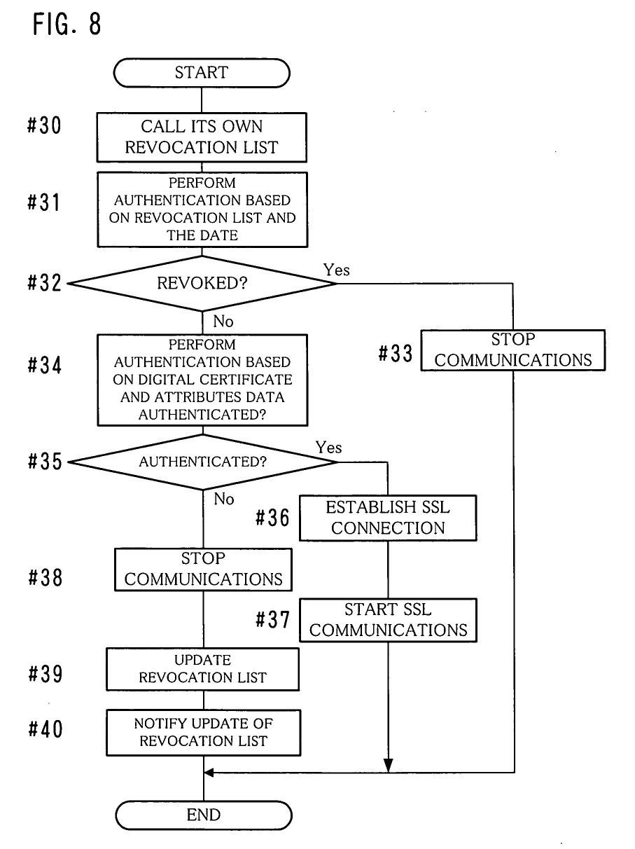

FIG. 7 is a diagram showing a processing flow when the SSL communication connection is established and FIG. 8 is a flowchart showing an example of a processing flow for examining the digital certificate DC.

A detailed description is provided, with reference to FIGS. 7 and 8, of the processing details of the respective portions shown in FIG. 3 when the PC1 and the PC2 shown in FIG. 4 attempt to perform desired communication.

Suppose that, in either terminal 2 of the PC1 or the PC2, a user operates a keyboard or the like to enter a command indicating that communication with other terminal 2 is intended. Responding to this, the command receiving portion 211 accepts the command, the transmission data creating portion 208 creates request data for connection (hereinafter referred to as “connection request data CR” and the data transmitting portion 209 sends the connection request data CR to the other terminal 2 (#11 in FIG. 7). In this case, suppose that the PC2 has sent the connection request data CR to the PC1.

Responding to this, in the PC1, the data receiving portion 204 receives the connection request data CR sent by the PC2 and the data analysis portion 205 analyzes the type of the data. Here, the data is naturally analyzed as connection request data. The transmission data creating portion 208 creates connection permission data CB indicating that the connection is allowed and sends the same to the PC2 (#12).

The data receiving portion 204 of the PC2 receives the connection permission data CB and predetermined processing is performed, so that the PC1 and the PC2 are connected to each other. At this point, however, the connection of the SSL communication has not been established yet. Accordingly, the desired communication is not started.

In either one of the PC1 or the PC2, the transmission data creating portion 208 generates SSL version data SV indicating supportable SSL versions and the data transmitting portion 209 sends the generated data to the other (#13). Here, suppose that the PC2 has sent the SSL version data SV to the PC1.

Responding to this, in the PC1, the data receiving portion 204 receives the SSL version data SV and the data analysis portion 205 analyzes the type of the data. The transmission data creating portion 208 selects one version that can be supported by the PC1 among the versions indicated in the SSL version data SV to generate SSL version selection data SD indicating the selected version. After that, the data transmitting portion 209 sends the generated data to the PC2 (#14).

In the PC2, when the data receiving portion 204 receives the SSL version selection data SD sent by the PC1, it is determined that the SSL version indicated therein is adopted as a protocol for the desired communication. Likewise, in the PC1, the similar determination is performed.

In each of the PC1 and the PC2, processing relating to a chain of X.509 signature is performed. The data transmitting portion 209 extracts its own digital certificate DC and its own attributes data PI from the data saving portion 202 and sends the digital certificate DC and the attributes data PI to the other end of the communication (#15).

The attributes data PI may be encrypted by a private key corresponding to its own digital certificate DC, then to be transmitted. In such a case, the terminal 2 that has received the attributes data PI may use a public key DCk attached to the digital certificate DC sent together with the attributes data PI and decode the attributes data PI. There is no need to send the digital certificate DC and the attributes data PI bidirectionally. They may be sent only from one of the terminals 2 to the other. For example, they may be sent only from the PC1 to the PC2 without sending them from the PC2 to the PC1. In this embodiment, a description is provided on the premise that the transmission is performed bidirectionally.

After exchanging the digital certificate DC and the attributes data PI, the PC1 informs the PC2 of the response completion (#16).

Next, before performing processing for sharing a common encryption key, i.e., a common key, the PC1 and the PC2 perform processing for authentication of the other end of the connection by confirming the validity of the digital certificate DC received from the other end of the connection. Such processing is performed by the revocation information confirming portion 206 and the authentication portion 207 according to the procedure shown in the flowchart of FIG. 8.

The revocation information confirming portion 206 calls the revocation list RL saved in the data saving portion 202 (#30 in FIG. 8). Then, the revocation information confirming portion 206 checks whether or not the received digital certificate DC of the other end of the connection is indicated in the revocation list RL and further checks whether or not the current date falls within the validity period of the digital certificate DC (#31).

If the digital certificate DC is indicated in the revocation list RL or if the current date is outside the validity period, then it is determined that the digital certificate DC is revoked (Yes in #32), so that the communications control portion 203 stops the communication with the other end of the connection (#33). Thereby, the processing in Step #17 and the subsequent processing shown in FIG. 7 are cancelled.

In contrast, if the digital certificate DC is not indicated in the revocation list RL and the current date falls within the validity period (No in #32), then the authentication portion 207 performs the determination processing of the validity of the digital certificate DC to perform an authentication process of the other end of the communication in the following manner (#34).

The authentication portion 207 compares the details of the attributes data PI with the details of the digital certificate DC of the other end of the communication. For example, the authentication portion 207 compares some items, e.g., the UUID and the domain name, that are common between the owner information DCp (see FIG. 5) of the digital certificate DC and the attributes data PI. After the comparison, if they match each other, then the authentication portion 207 authenticates the other end of the communication. If they do not match each other, the other end of the communication shall be determined to be unauthenticated. If it is possible to connect to a server of a certificate authority that has issued the digital certificate DC, the latest CRL of the certificate authority is referred to and to confirm whether or not the digital certificate DC is revoked. If the digital certificate DC is revoked, then the other end of the communication shall be determined to be unauthenticated.

If the other end of the communication cannot be authenticated (No in #35), then the communications control portion 203 stops the communication with the other end of the connection (#33) to cancel the processing in Step #17 and the subsequent processing shown in FIG. 7. In parallel with this or before or after, the data manipulation managing portion 210 adds information on the digital certificate DC to its own revocation list RL so that the digital certificate DC received from the other end of the communication is regarded as a revoked digital certificate (#39). The transmission data creating portion 208 sends revocation list update data UC indicating the digital certificate DC to the other terminal 2 with which the terminal 2 itself is associated (#40). The other terminal 2 that has received the revocation list update data UC updates its own revocation list RL based on the received revocation list update data UC. This will be described later.

If the other end of the communication can be authenticated (Yes in #35), then the connection of the SSL communication with the other end of the communication is established (#36), and the desired communication using the SSL is started (#37). The processing is described with reference back to FIG. 7.

If the PC1 and the PC2 can be authenticated, either one of the PC1 or the PC2 creates a premaster key PMK that is an arbitrary value with 384 bits in order to create a common key that is used by the PC1 and the PC2 through the SSL communication. Here, suppose that the PC2 creates such a premaster key PMK. The transmission data creating portion 208 of the PC2 uses the public key DCk included in its own digital certificate DC to encrypt the premaster key PMK and sends the encrypted premaster key PMK to the PC1 (#17). Further, the transmission data creating portion 208 of the PC2 sends to the PC1 a message indicating that a common key should be created and the encryption key for communication should be switched to the common key (#18).

In the PC1, when receiving the premaster key PMK, the data receiving portion 204 uses a private key corresponding to its own digital certificate DC to decode the premaster key PMK. When the data analysis portion 205 analyzes the premaster key PMK to confirm that the type of the data is a premaster key, the communications control portion 203 uses the received premaster key PMK to create a common key KYP and performs control processing so that encryption communication using the common key KYP is performed with the PC2 in the future. In short, the encryption keys are switched.

Likewise, in the PC2, the communications control portion 203 uses the premaster key PMK that has been sent to the PC1 to create a common key KYP and performs control processing so that encryption communication using the common key KYP is performed with the PC1 in the future. In other words, the encryption keys are switched. Note that the PC1 and the PC2 use the same function or others to create the common keys KYP respectively. Thus, the common keys KYP created by the respective PC1 and PC2 are naturally the same.

By the processing described above, the connection of the SSL communication is established between the PC1 and the PC2 (#19). Thereby, the desired communication can be performed safely.

[Update Processing of the Revocation List RL]

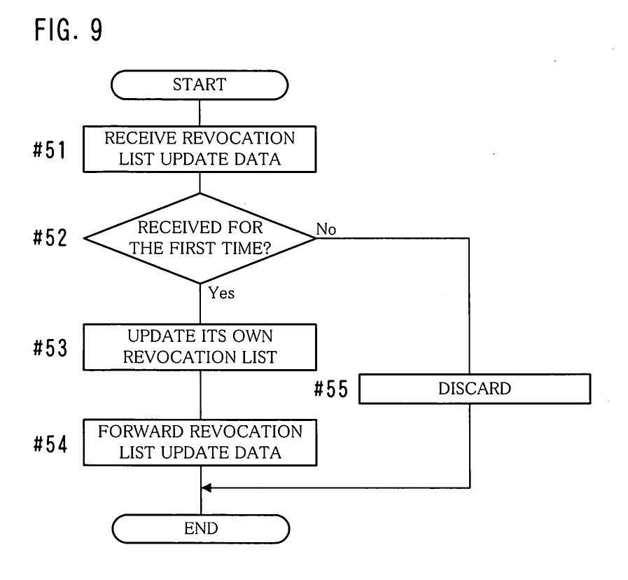

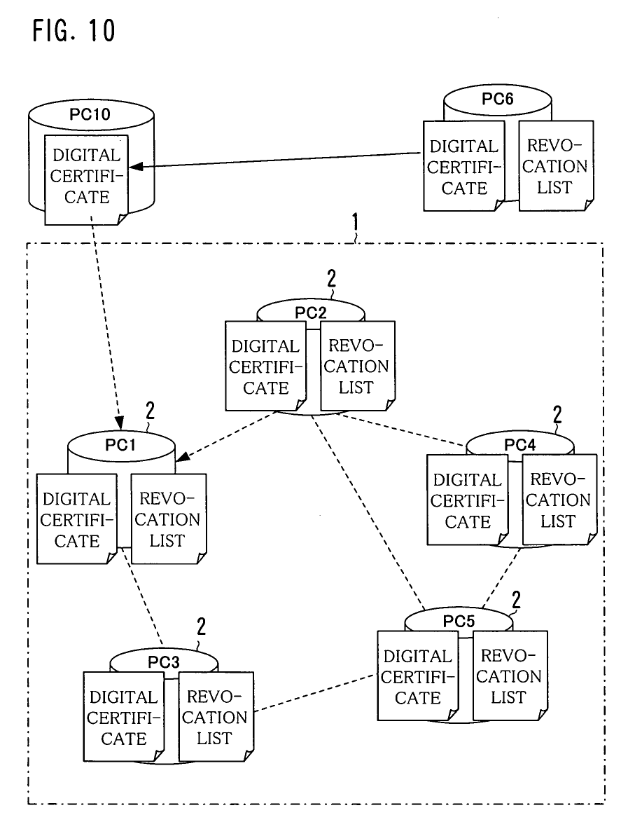

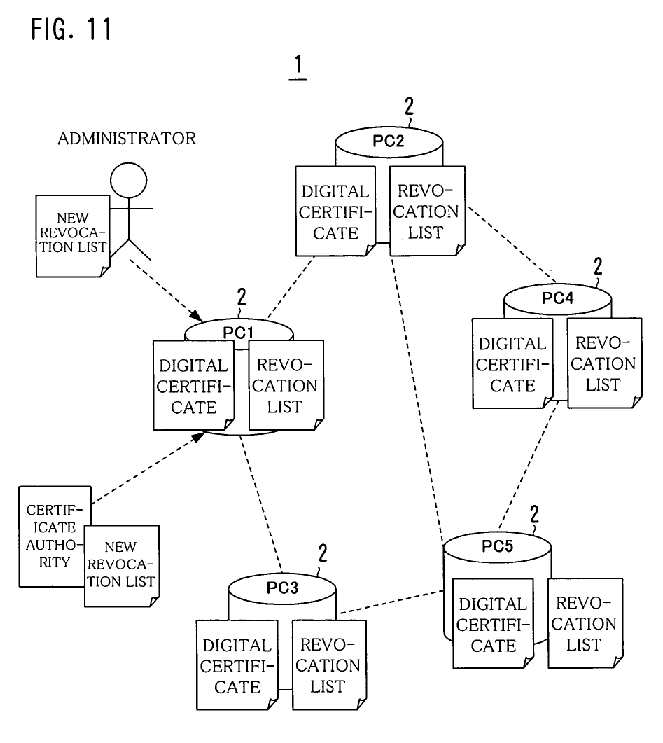

FIG. 9 is a flowchart showing an example of a processing flow when information on a revoked digital certificate DC or a digital certificate DC with no credibility is informed by other terminal 2, FIG. 10 is a diagram showing an example of processing when a digital certificate DC of a discarded terminal 2 is to be used by other terminal 2 in a fraudulent manner and FIG. 11 is a diagram showing an example of processing when information on the revoked digital certificate DC is obtained from an administrator or a certificate authority.

As described earlier with reference to FIG. 8, before starting the desired communication, the terminal 2 obtains the digital certificate DC of the other end of the communication (connection) to perform an authentication process of the other end of the communication. On this occasion, unless the revocation list RL of the terminal 2 indicates the digital certificate DC, then the terminal 2 uses the attributes data PI of the other end of the communication to check the credibility of the digital certificate DC. If the digital certificate DC has no credibility, then the terminal 2 determines that the other end of the communication cannot be authenticated, so that the desired communication is stopped. Then, the terminal 2 adds information on the digital certificate DC with no credibility to its own revocation list RL. Further, the terminal 2 sends the revocation list update data UC to other terminal 2 with which the terminal 2 itself is associated.

Stated differently, in the case where the terminals 2 in the network 1 newly find a digital certificate DC with no credibility, they disclose such information to one another. The following is a detailed description of processing when a digital certificate DC with no credibility is found.

The processing in the terminal 2 that has found the digital certificate DC with no credibility is as described above. Meanwhile, a terminal 2 that has received from other terminal 2 a notice that the digital certificate DC with no credibility has been found, i.e., the revocation list update data UC performs processing according to the procedure shown in FIG. 9.

When the terminal 2 receives the revocation list update data UC (#51), in the case where the terminal 2 has never received revocation list update data UC that is the same as the received revocation list update data UC, i.e., in the case where the terminal 2 receives the revocation list update data UC for the first time (Yes in #52), the terminal 2 adds to its own revocation list RL information on the digital certificate DC with no credibility indicated in the revocation list update data UC and updates the revocation list RL (#53). However, if the information is already written by another method, it is unnecessary to update the revocation list RL.

In parallel with the processing in Step #53 or before or after, the terminal 2 forwards the revocation list update data UC to other terminal 2 with which the terminal 2 itself is associated. This is because yet other terminal 2 in the network 1 is to be notified of the information on the digital certificate DC with no credibility. Note, however, that it is unnecessary to send the revocation list update data UC to the terminal 2 that has forwarded the same.

In contrast, in the case where the terminal 2 has ever received the same revocation list update data UC in the past, the terminal 2 discards the received revocation list update data UC (#55). This is because the revocation list RL is supposed to have been updated based on the revocation list update data UC received in the past. In some cases, however, the revocation list RL may not have been updated for some reason. Accordingly, the revocation list RL is updated in the case where the digital certificate DC indicated in the revocation list update data UC is not shown in the revocation list RL.

Such processing for updating the revocation list RL is performed, for example, in the case shown in FIG. 10.

Referring to FIG. 10, suppose that the PC6 is discarded. Upon discarding the PC6, an administrator of the PC6 performs, for a certificate authority, appropriate procedures necessary for revoking a digital certificate DC of the PC6 in accordance with rules of a Public Key Infrastructure (PKI). Further, the administrator completely deletes the digital certificate DC and a private key corresponding thereto. The administrator performs such procedures and deletion in order to prevent the digital certificate DC of the PC6 from being used in a fraudulent manner. However, suppose that the digital certificate DC and the private key of the PC6 leak out due to an operation error or the like and a user of the PC10 obtains them in a fraudulent manner to attempt to perform communication with the PC1.

In such a case, upon communication between the PC1 and the PC10, even if the PC10 presents the fraudulent digital certificate DC, i.e., the digital certificate DC leaked from the PC6, the PC1 can confirm that the digital certificate DC is revoked based on its own revocation list RL or the latest CRL of a certificate authority. If no information on the digital certificate DC is indicated in its own revocation list RL, then the information is immediately added to the revocation list RL. In parallel with this, the PC1 sends to other terminal 2 revocation list update data UC regarding the digital certificate DC. The terminal 2 that has received the revocation list update data UC forwards the same to a further different terminal 2. If the terminal 2 that has received the revocation list update data UC has no information on the digital certificate DC in its own revocation list RL, then the terminal 2 immediately adds the information to the revocation list RL.

If the PC1 cannot confirm that the digital certificate DC is revoked based on any of its own revocation list RL and the latest CRL of the certificate authority, or if the PC1 cannot obtain the latest CRL of the certificate authority, the PC1 compares the attributes data PI obtained from the PC10 with the digital certificate DC, then to check the credibility of the digital certificate DC. Then, if the PC1 determines that the digital certificate DC has no credibility, then the PC1 adds the information on the digital certificate DC to its own revocation list RL and sends the revocation list update data UC to other terminal 2.

The processing for updating the revocation list RL is performed also in the case shown in FIG. 11. An administrator enters, into the terminal 2, e.g., into the PC1, information on a newly-found digital certificate DC with no credibility or on a revoked digital certificate DC. Alternatively, the PC1 receives the latest CRL from a server of a certificate authority at regular intervals. Responding to this, the PC1 adds to its own revocation list RL the information on the digital certificate DC thus entered and the information on a newly revoked digital certificate DC indicated in the received CRL. Further, the PC1 sends revocation list update data UC indicating the information to other terminal 2.

Incidentally, as long as the procedures for revocation of a digital certificate is appropriately performed, even if other terminal 2 attempts to use the digital certificate in a fraudulent manner, damage to a third party can be prevented effectively. Suppose, for example, that the PC10 obtains the digital certificate DC of the discarded PC6 in a fraudulent manner and attempts to perform communication with the PC1 using the obtained digital certificate DC. If the procedures for revocation of the digital certificate DC is appropriately performed, the PC1 can confirm that the digital certificate DC is revoked based on the latest CRL of a certificate authority, so that communication with the PC10 can be stopped.

In conventional cases, however, the problem arises where a digital certificate DC is used in a fraudulent manner even if the procedures for revocation of the digital certificate DC is appropriately performed. For example, in the case where the PC1 cannot connect to a server of a certificate authority due to the setting for the firewall 5, it is not known in some cases that the digital certificate DC sent from the PC10 is revoked. However, in this embodiment, a terminal 2 capable of connecting to a server of a certificate authority distributes information on revocation to a terminal 2 incapable of connecting thereto. Thus, the problems pointed out above can be solved.

As described above, in this embodiment, the terminals 2 in the network 1 exchange, with one another, information on a revoked digital certificate DC and on a digital certificate DC with no credibility that should be determined to be revoked. Thus, even in a terminal 2 that cannot connect to a server of a certificate authority due to the setting for the firewall 5, the latest information on a digital certificate DC can be obtained more easily than conventional cases. This can improve the reliability of the determination whether or not a digital certificate DC of the other end of the communication is valid and the safety of communication in comparison with the conventional cases.

Further, according to this embodiment, a digital certificate DC is evaluated based on attributes data PI of the other end of the communication, in addition to an own revocation list RL and a CRL published by a certificate authority. Thus, it is possible to further improve the reliability of the determination of the validity of a digital certificate DC and the safety of communication.

In this embodiment, the descriptions are provided of the case where personal computers are used as the terminals 2. Instead, however, the present invention can be applied to image forming apparatuses such as Multi Function Peripherals (MFPs), workstations, portable terminals and other various types of information processors.

In this embodiment, descriptions are provided of the case where the terminals 2 belonging to the LAN network 1 exchange information on a digital certificate DC. Instead, however, the present invention can be applied to the case where the terminals 2 belonging to a wide area network such as the Internet exchange information. The terminal 2 can perform an authentication process of the other end of the communication that is a device joining other network.

According to this embodiment, if the other end of communication cannot be authenticated, in other words, if the authenticity of the other end cannot be verified, the communication with the other end is stopped. However, another system configuration is possible in which limitation is added to a function for communicating with the other end instead of stopping the communication completely.

The present invention makes it possible to ensure that the validity of a digital certificate can be determined compared to conventional cases. Further, the present invention can prevent fraudulent communication with an identity thief more surely than the conventional cases.

In the embodiment described above, the overall configuration of the network 1 and the terminal 2, the configurations of various portions thereof, the details of processing, the processing order, the details of the tables, the key length of the encryption keys and the like may be changed as needed, in accordance with the subject matter of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A method for managing communication in an information processor, the method comprising:
storing, in a memory, revoked certificate information indicating a revoked digital certificate;
receiving a digital certificate of an other end of the communication therefrom;
determining, based on the revoked certificate information, whether the digital certificate thus received is revoked;
receiving information on a digital certificate that is newly revoked;
updating the revoked certificate information stored in the memory based on the received information on the digital certificate that is newly revoked; and
sending information on the digital certificate that is newly revoked to other information processor.

2. The method according to claim 1, wherein when it is determined that the digital certificate of the other end of the communication is revoked, the communication with the other end of the communication is stopped.

3. The method according to claim 2, further comprising
receiving attributes data of the other end of the communication therefrom,
comparing the digital certificate with the attributes date to verify authenticity of the other end of the communication, and
when the authenticity of the other end of the communication cannot be verified, determining that the digital certificate of the other end of the communication is revoked, updating the revoked certificate information, and sending, to other information processor, information indicating that the digital certificate of the other end of the communication is revoked.

4. A method for managing communication in an information processor, the method comprising:
storing, in a memory, revoked certificate information indicating a revoked digital certificate;
receiving a digital certificate and attributes data of an other end of the communication therefrom;
comparing the digital certificate with the attributes data of the other end of the communication to verify authenticity of the other end of the communication, and
when the authenticity of the other end of the communication cannot be verified, determining that the digital certificate of the other end of the communication is revoked, updating the revoked certificate information, and sending, to other information processor, information indicating that the digital certificate of the other end of the communication is revoked.

5. The method according to claim 4, wherein when the authenticity of the other end of the communication cannot be verified, the communication with the other end of the communication is stopped.

6. A method for managing a digital certificate in a network made up of a plurality of nodes, the method comprising:
in each of the nodes, storing revoked certificate information indicating a revoked digital certificate;
when each of the nodes finds an other end of communication that cannot be authenticated, adding a digital certificate of the other end of the communication to the revoked certificate information of the node and notifying other node of presence of a digital certificate that is newly revoked; and
in the other node that has received the notification, updating the revoked certificate information stored in the node.

7. The method according to claim 6, wherein each of the nodes compares the digital certificate with attributes data of the other end of the communication to verify authenticity of the other end of the communication.

8. An information processor comprising:
a receiving portion that receives a digital certificate from an other end of communication;
an authentication portion that verifies authenticity of the other end of the communication based on the digital certificate received by the receiving portion;
a memory that stores revoked certificate information indicating a revoked digital certificate;
an updating portion that updates the revoked certificate information stored in the memory when a digital certificate that is newly revoked is found; and
a transmission portion that sends new revoked certificate information to other information processor when the digital certificate that is newly revoked is found, the new revoked certificate information indicating that the digital certificate is revoked.

9. The information processor according to claim 8, further comprising a control portion that stops the communication with the other end of the communication when the authentication portion cannot verify the authenticity of the other end of the communication.

10. The information processor according to claim 8, wherein the authentication portion determines whether the digital certificate received by the receiving portion is revoked based on the revoked certificate information stored in the memory.

11. The information processor according to claim 8, wherein
the receiving portion further receives attributes data from the other end of the communication, and
the authentication portion compares the attributes data with the digital certificate of the other end of the communication to verify the authenticity of the other end of the communication.

12. An information processor comprising:
a memory that stores revoked certificate information indicating a revoked digital certificate;
a first updating portion that updates the revoked certificate information stored in the memory when a digital certificate that is newly revoked is found;
a transmission portion that sends new revoked certificate information to other information processor when the digital certificate that is newly revoked is found, the new revoked certificate information indicating that the digital certificate is revoked; and
a second updating portion that updates the revoked certificate information stored in the memory based on new revoked certificate information sent by other information processor.

13. The information processor according to claim 12, further comprising
a receiving portion that receives a digital certificate from an other end of communication, and
an authentication portion that verifies authenticity of the other end of the communication based on the digital certificate received by the receiving portion,
wherein the first updating portion updates the revoked certificate information stored in the memory when the authentication portion cannot verify the authenticity of the other end of the communication.

14. The information processor according to claim 13, further comprising a control portion that stops the communication with the other end of the communication when the authentication portion cannot verify the authenticity of the other end of the communication.

15. The information processor according to claim 13, wherein
the receiving portion further receives attributes data from the other end of the communication, and
the authentication portion compares the attributes data with the digital certificate of the other end of the communication to verify the authenticity of the other end of the communication.
